(19) United States
(12) Patent Application Publication
(10) Pub. No.: US 2021/0370343 A1
(43) Pub. Date: Dec. 2, 2021

(54) Spot Gluing, Feeding and Cutting Automata for Horn Assembly

(71) Applicant: Innovation Sound Technology Co., Ltd., Shenzhen, Guangdong (CN)

(72) Inventors: Shun Ming Yuen, Shenzhen, Guangdong (CN); Qingshan Tang, Shenzhen, Guangdong (CN); Dehui Liang, Shenzhen, Guangdong (CN)

(21) Appl. No.: 17/256,226

(22) PCT Filed: Jan. 10, 2020
(86) PCT No.: PCT/CN2020/071266

§ 371 Date: Dec. 27, 2020

(30) Foreign Application Priority Data
Dec. 26, 2019 (CN) 201911361516.8

(51) Int. Cl. B05C 13/02; B05C 5/02; B65G 47/91

(52) U.S. Cl. CPC B05C 13/02; B65G 47/912; B05C 5/0208

(57) ABSTRACT

The invention belongs to the field of automatic equipment technology, and discloses a spot gluing, feeding and cutting automata for horn assembly, wherein products are transported and delivered through an automatic feeding and cutting module for horns and horn hoods; horns and horn hoods are grabbed onto a bearing platform module by a grabbing module; circular spot gluing is done by a gluing module and a carrier module; and finally horn disks are automatically assembled by an unloading module with defective products removed. Different workstations perform their duties and work closely together, so as to realize the automatic delivery of products, automatic assembly of horns into horn hoods, automatic gluing, and automatic assembly and recovery of horn disks. The automata features high efficiency, stable quality, high degree of automation, good effect, low production cost, and convenient, simple and fast use.

### FIELD OF THE INVENTION

The invention relates to the field of automatic equipment technology, and particularly to a spot gluing, feeding and cutting automata for horn assembly.

### BACKGROUND OF THE INVENTION

The traditional gluing for horn assembly is mainly done by manual operation, which features low efficiency, frequent feeding and reclaiming, high costs of manual labor. Moreover, the manual operation is prone to deviations and very poor uniformity, resulting in uneven gluing, defective products, poor product effects, and a low rate of finished products. The fact that the gluing quality cannot be guaranteed leads to a high rejection rate. In addition, frequently and manually picking and placing makes labor intensity high, and operators' hands easy to stick glue, which causes the operators to be mentally stressed.

### DESCRIPTION OF THE INVENTION

The present invention is intended to overcome the existing defects and effectively solve the technical matters in the background art by providing a spot gluing, feeding and cutting automata for horn assembly.

In order to solve the above technical problems, the present invention provides the following technical solutions:

The invention provides a spot gluing, feeding and cutting automata for horn assembly comprising:

A rack, and

An enclosure disposed on the rack; and

An automatic feeding and cutting module for horns disposed on the rack, which automatically feeds horns and automatically recovers plastic trays with horns; and

A feeding and cutting module for horn hoods (30) arranged on the rack, which realizes automatic feeding of horn hoods and automatic recovery of plastic trays with horn hoods; and

A grabbing module arranged on the rack, which is assisted by CCD to realize grabbing of horn hoods and the horns; and

A gluing module arranged on the rack, which, with the assistance of CCD, does gluing for solidification after horns are fixed into horn hoods; and

An unloading module arranged on the rack, which is used for automatic loading of finished products, and selection and removal of defective products; and

A carrier module provided on the rack, which is used as a bearing platform; and

An exhaust module provided at the bottom of the rack, which is used to cool the control system in the cabinet; and

A three-color warning light set on the enclosure, which is used to indicate different operating states of the machine; and

A man-machine interface module arranged on the enclosure.

As a preferred technical solution of the present invention, the spot gluing, feeding and cutting automata for horn assembly further includes:

A double-control emergency stop button, which is arranged on the front of the upper panel to the enclosure.

As a preferred technical solution of the present invention, the automatic feeding and cutting module for horns includes:

A delivery belt module for defective products;

No. 1 horn disk recovery module, one end of which is connected to the delivery belt module for defective products;

No. 1 rail module, one end of which is connected to the other end of the No. 1 horn disk recovery module;

No. 1 block module, which is disposed above the No. 1 rail module;

No. 1 tray carrying module, one end of which is connected to one end of the block module.

As a preferred technical solution of the present invention, the delivery belt module for defective products includes:

No. 1 skeleton;

A fixed vertical plate, which is connected to both sides of the No. 1 skeleton;

A belt line, which is provided above the No. 1 skeleton;

No. 1 motor, which is provided at one end of the belt line;

The No. 1 horn disk recovery module includes:

No. 1 skeleton;

No. 1 ratchet rod, which is arranged below the No. 1 skeleton;

No. 1 cylinder, which is provided below the No. 1 ratchet rod;

No. 2 cylinder, which is provided below the No. 1 cylinder;

No. 1 sensor, which is arranged on one side of the No. 1 ratchet rod.

The No. 1 rail module includes:

No. 1 belt;

No. 5 skeleton, which is provided below the No. 1 belt;

No. 1 block, which is provided on one side of the No. 1 belt;

A fixing block for No. 1 skeleton, which is provided at the bottom of the No. 5 skeleton;

Fixing frame for No. 1 belt, which is provided on one side of the fixing block for No. 1 skeleton;

No. 2 motor, which is provided at one end of the No. 1 belt.

As a preferred technical solution of the present invention, the feeding and cutting module for horn hoods includes:

No. 2 horn disk recovery module;

No. 2 block module, which is provided on one side of the No. 2 horn disk recovery module;

No. 3 block module, which is provided on one side of the No. 2 block module;

No. 2 rail module, which is provided on one side of the No. 3 block module;

No. 2 tray carrying module, which is arranged on one side of the No. 2 rail module.

As a preferred technical solution of the present invention, the No. 2 horn disk recovery module includes:

No. 3 skeleton, No. 2 ratchet rod, a guard plate, No. 16 cylinder and No. 2 sensor;

No. 2 rail module includes No. 2 belt, No. 4 skeleton, No. 2 block, fixing block for No. 1 skeleton, No. 4 motor and No. 3 motor.

One or a plurality of technical solutions provided in the present invention have at least the following technical effects or advantages:

Products are transported and delivered through an automatic feeding and cutting module for horns and horn hoods; horns and horn hoods are grabbed onto a bearing platform module by a grabbing module; circular spot gluing is done by a gluing module and a carrier module; and finally horn disks are automatically assembled by an unloading module with defective products removed. Different workstations perform their duties and work closely together, so as to realize the automatic delivery of products, automatic assembly of horns into horn hoods, automatic gluing, and automatic assembly and recovery of horn disks. The automata features high efficiency, stable quality, high degree of automation, good effect, low production cost, and convenient, simple and fast use, able to effectively solve the problems in the background technology.

### BRIEF INTRODUCTION OF THE DRAWINGS

The accompanying drawings are used to provide a further understanding of the present invention, and constitute a part of the specification. Together with the embodiments of the present invention, they are used to explain the present invention but shall not constitute a limitation to the present invention.

In the accompanying drawings:

FIG. 1 is a three-dimensional front structural view of the appearance of a spot gluing, feeding and cutting automata for horn assembly according to an embodiment of the present invention;

FIG. 2 is a three-dimensional view of the overall structure of a spot gluing, feeding and cutting automata for horn assembly according to an embodiment of the present invention;

FIG. 3 is a three-dimensional structural view of a spot gluing, feeding and cutting automata for horn assembly according to an embodiment of the present invention;

FIG. 4 is a three-dimensional view of a belt module for defective products in a spot gluing, feeding and cutting automata for horn assembly according to an embodiment of the present invention;

FIG. 5 is a three-dimensional structural view of the empty tray recovery device in an automatic feeding and cutting module for horns of a spot gluing, feeding and cutting automata for horn assembly according to an embodiment of the present invention;

FIG. 6 is a three-dimensional view of the belt structure in an automatic feeding and cutting module for horns of a spot gluing, feeding and cutting automata for horn assembly according to an embodiment of the present invention;

FIG. 7 is a three-dimensional view of the block structure in an automatic feeding and cutting module for horns of a spot gluing, feeding and cutting automata for horn assembly according to an embodiment of the present invention;

FIG. 8 is a three-dimensional view of the tray loading structure in an automatic feeding and cutting module for horns of a spot gluing, feeding and cutting automata for horn assembly according to an embodiment of the present invention;

FIG. 9 is a three-dimensional view of the feeding and cutting module for horn hoods in a spot gluing, feeding and cutting automata for horn assembly according to an embodiment of the present invention;

FIG. 10 is a three-dimensional structural view of the finished product collecting module in a feeding and cutting module for horn hoods of a spot gluing, feeding and cutting automata for horn assembly according to an embodiment of the present invention;

FIG. 11 is a three-dimensional view of block structure in a feeding and cutting module for horn hoods of a spot gluing, feeding and cutting automata for horn assembly according to an embodiment of the present invention;

FIG. 12 is a three-dimensional structural view of the belt module in a feeding and cutting module for horn hoods of a spot gluing, feeding and cutting automata for horn assembly according to an embodiment of the present invention;

FIG. 13 is a three-dimensional view of the tray carrying structure in a feeding and cutting module for horn hoods of a spot gluing, feeding and cutting automata for horn assembly according to an embodiment of the present invention;

FIG. 14 is a three-dimensional structural view of the grabbing module in a spot gluing, feeding and cutting automata for horn assembly according to an embodiment of the present invention;

FIG. 15 is a three-dimensional structural view of the gluing module in a spot gluing, feeding and cutting automata for horn assembly according to an embodiment of the present invention;

FIG. 16 is a three-dimensional structural view of the unloading module in a spot gluing, feeding and cutting automata for horn assembly according to an embodiment of the present invention;

FIG. 17 is a three-dimensional structural view of the carrier module in a spot gluing, feeding and cutting automata for horn assembly according to an embodiment of the present invention;

Numbers in the drawings: rack 11, enclosure 12, man-machine interface module 13, dual-control emergency stop button 14, three-color warning light 15, exhaust module 16, air intake controller 17,

Automatic feeding and cutting module for horns 20, delivery belt module for defective products 21, No. 1 skeleton 211, fixed vertical plate 212, belt line 213, No. 1 motor 214

No. 1 horn disk recovery module 22, No. 1 skeleton 221, No. 1 ratchet rod 222, No. 1 cylinder 223, No. 2 cylinder 224, No. 1 sensor 225

No. 1 rail module 23, No. 1 belt 231, No. 5 skeleton 232, No. 1 block 233, fixing block (234) for No. 1 skeleton, fixing frame for No. 1 belt 235, No. 1 motor 236

No. 1 block module 24, No. 1 block 244, No. 2 block 243, No. 3 block 242, No. 4 block 241

No. 1 tray carrying module 25

No. 3 cylinder 252, No. 4 cylinder 253, No. 5 cylinder 254, No. 6 cylinder 255, No. 7 cylinder 256, No. 8 cylinder 257, No. 9 cylinder 258, No. 10 cylinder 259, No. 11 cylinder 2511, No. 12 cylinder 2512, No. 13 cylinder 2513, No. 14 cylinder 2514, No. 15 cylinder 2515, sensor 259 for plastic trays loaded with horns

Feeding and cutting module for horn hoods 30

No. 2 horn disk recovery module 31, No. 3 skeleton 311, No. 2 ratchet rod 312, guard plate 313, No. 16 cylinder 314, No. 2 sensor 315

No. 2 block module 32, No. 5 block 321, No. 6 block 322, No. 7 block 323, No. 8 block 324,

No. 3 block module 33, No. 9 block 331, No. 10 block 332, No. 11 block 333, No. 12 block 334

No. 2 rail module 34, No. 3 motor 344

No. 2 belt 342, No. 4 skeleton 341, No. 2 block 345, cover 346, fixing block for No. 1 skeleton 347, No. 4 motor343

No. 2 tray carrying module 35

Grabbing module 40

No. 1 column 41, No. 1 X-direction screw 411, No. 1 X-axis motor 412, fixed code 413

Rotary motor 42, gripper module 43, light source 44, No. 1 CCD module 45, No. 1 Z-direction screw 46, No. 1 Z-axis motor 47, Y-axis screw 48, Y-axis motor 49

Gluing module 50, No. 2 column 51, No. 2 X-axis motor 52, gluing system 53, No. 2 Z-direction screw 54, No. 2 CCD module 55, No. 2 Z-axis motor 56, No. 2 X-direction screw 57, fixed code 58

Unloading module 60, No. 3 column 61, No. 3 X-axis motor 62, No. 3 X-direction screw 63, Z-direction (1) sliding table 64, Z-direction (2) sliding table 65, No. 1 suction cup 66, No. 2 suction cup 67, fixed code 68

Carrier module 70, No. 1 screw 71, No. 2 screw 72, No. 1 bearing platform 73, No. 2 bearing platform 75, No. 1 pressure cylinder 74, No. 2 pressure cylinder 76, No. 5 motor 77, No. 6 Motor 78.

### DETAILED DESCRIPTION OF THE PREFERRED EMBODIMENTS

In order to make the objectives, technical solutions and advantages of the present invention clearer, further descriptions are presented below on the invention in detail with reference to the accompanying drawings and embodiments. It shall be understood that the specific embodiments described herein are only used to interpret the present invention, but not to limit the present invention.

It shall be noted that when an element is referred to as being “fixed to” or “disposed on” another element, it may be directly on the other element or indirectly on the other element. When an element is said to be “connected to” another element, it may be directly connected to the other element or indirectly connected to the other element.

In the description of the present invention, it shall be understood that the orientation or positional relationship indicated by the terms such as “length”, “width”, “upper”, “lower”, “front”, “rear”, “left”, “right”, “vertical”, “horizontal”, “top”, “bottom”, “inside”, “outside” are based on the orientation or positional relationship shown in the drawings, which are only for the convenience of describing the present invention and simplifying the description, rather than indicate or imply that the specified device or element must have a specific orientation, or must be constructed and operated in a specific orientation. Therefore, it shall not be understood as a limitation on the present invention.

In addition, the terms “No. 1” and “No. 2” are only used for descriptive purposes, and shall not be understood as indicating or implying relative importance or implicitly indicating the number of specified technical features. Hence, the features defined with “No. 1” and “No. 2” may explicitly or implicitly include one or a plurality of these features. In the description of the present invention, “a plurality of” means two or more than two, unless otherwise specifically defined.

To better understand the above technical solutions, the above technical solutions will be described in detail below in conjunction with the drawings to the specification and specific implementations.

Embodiments 1

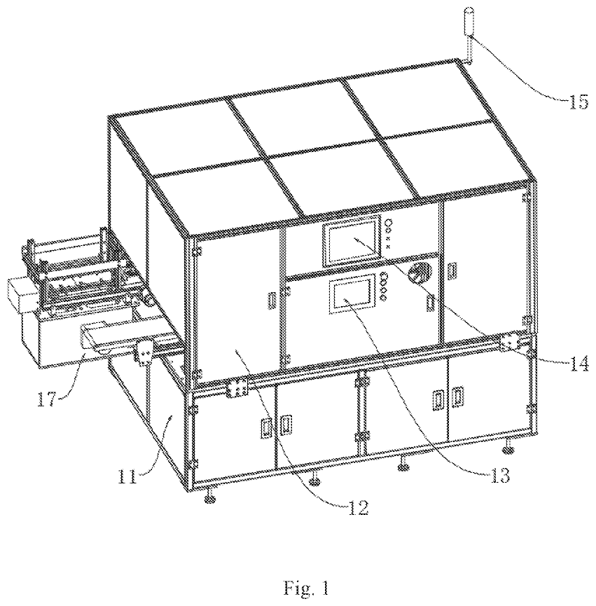

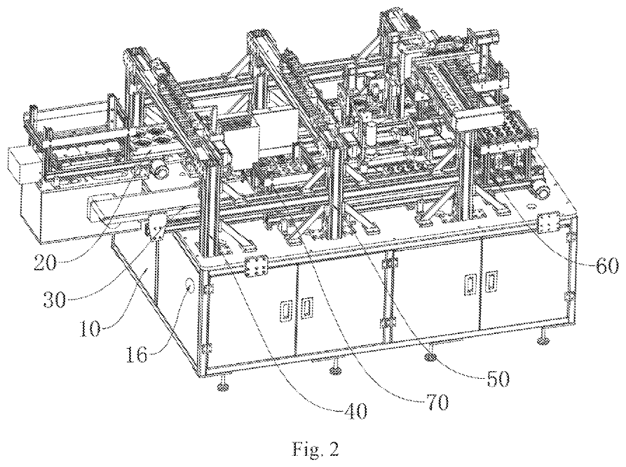

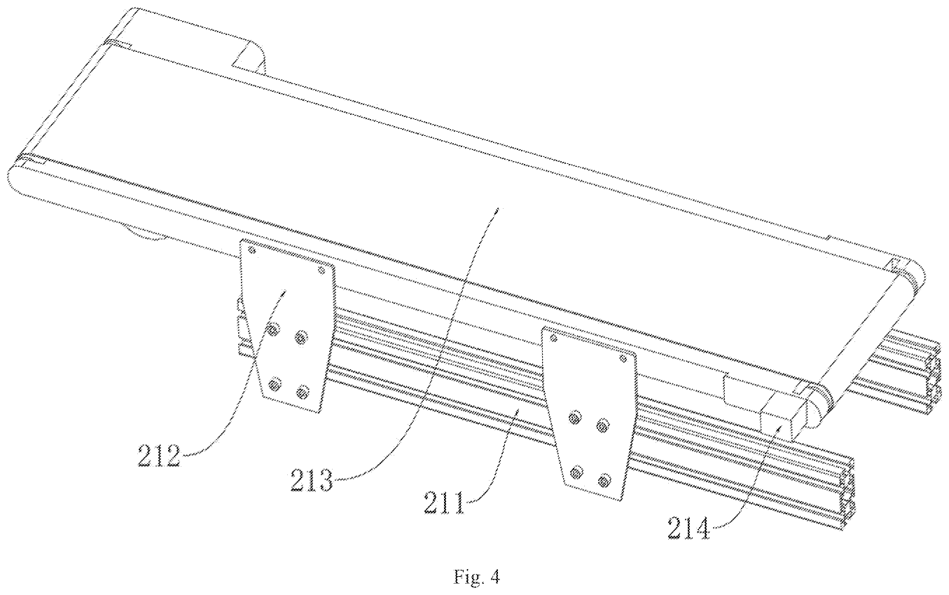

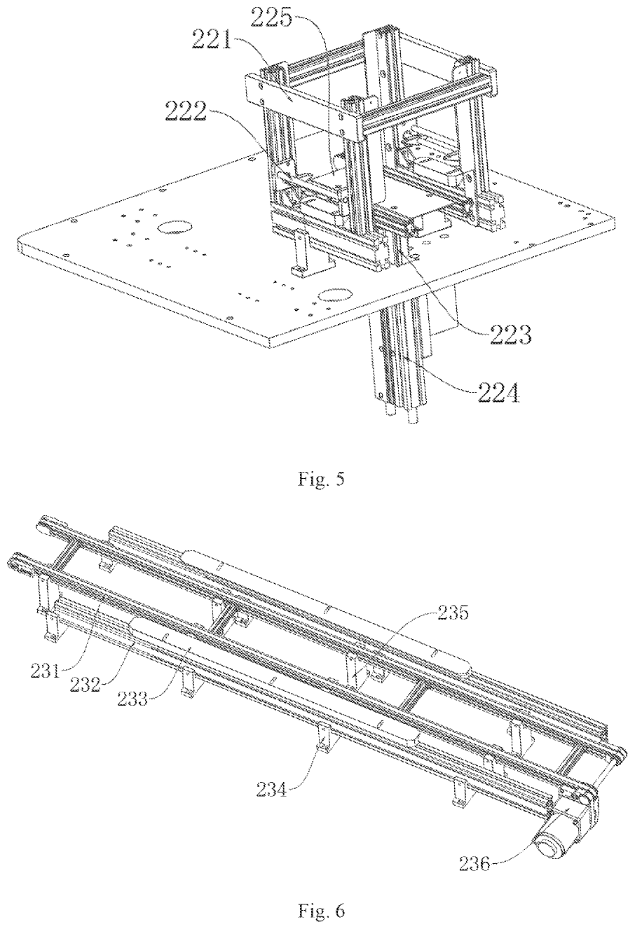

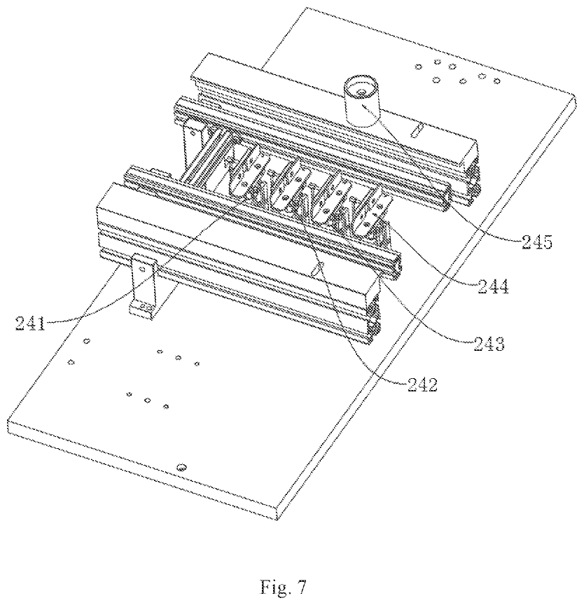

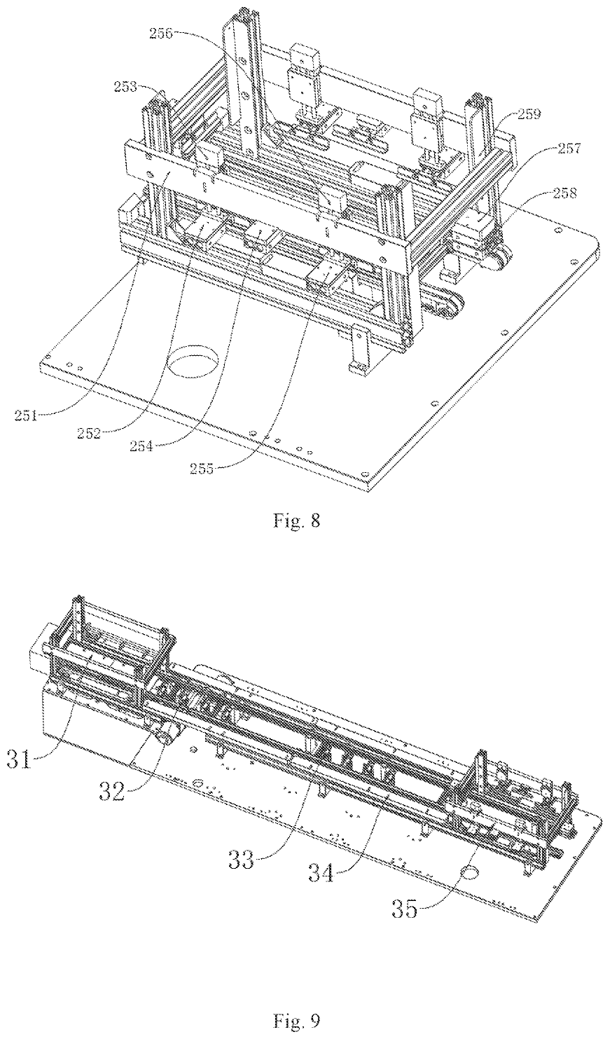

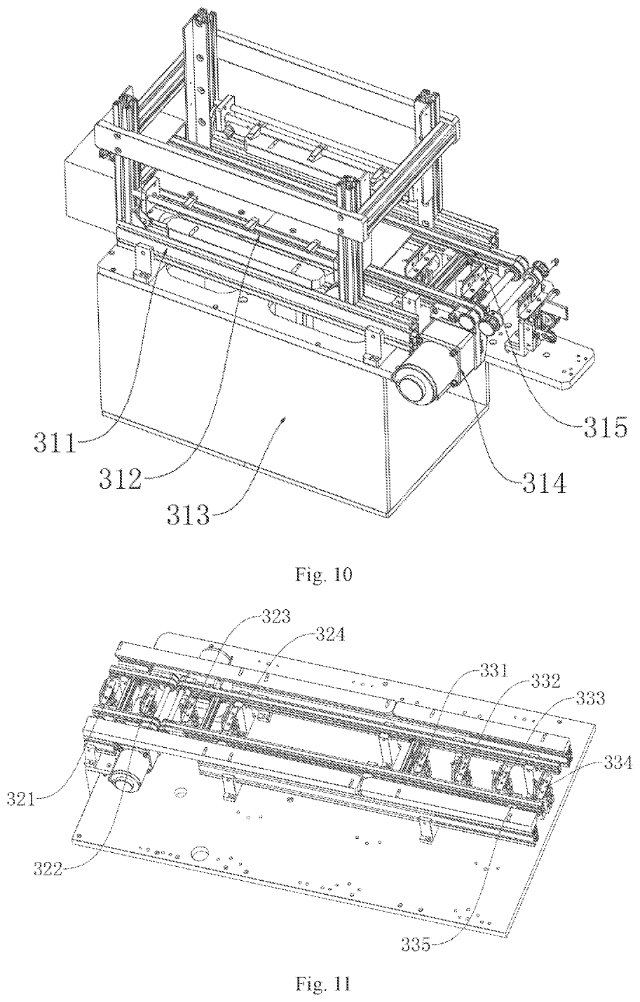

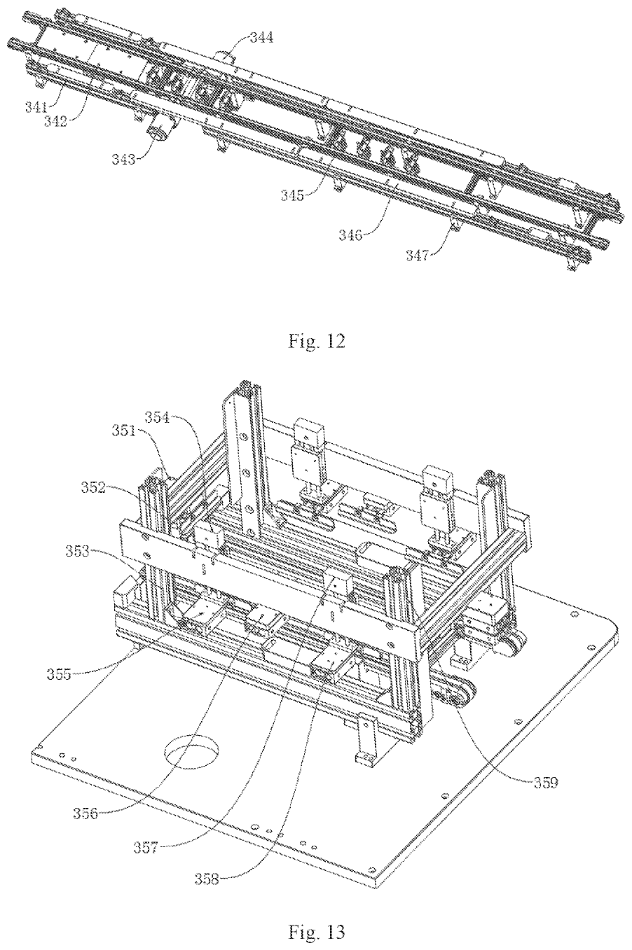

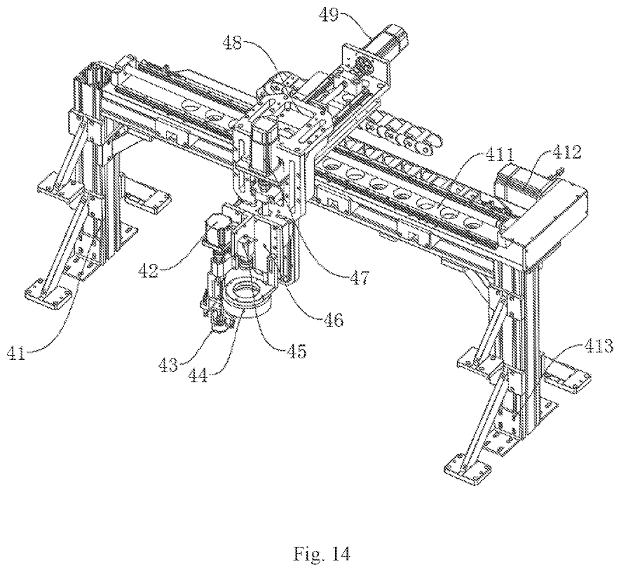

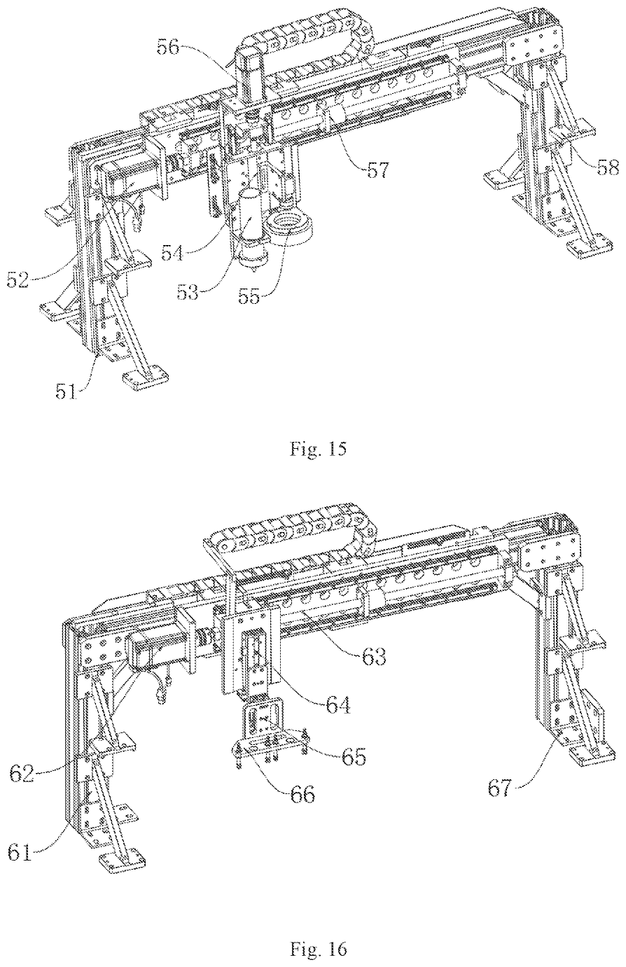

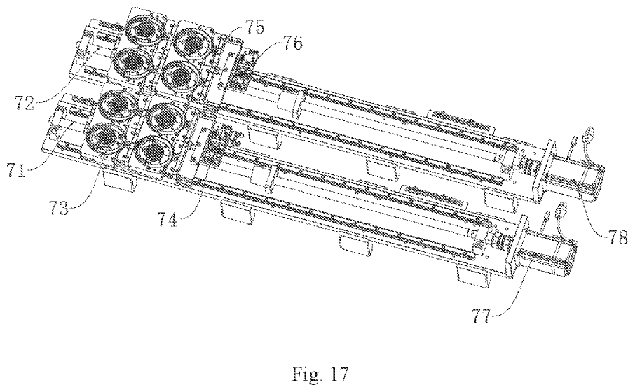

With reference to FIG. 1-17, the present invention discloses a spot gluing, feeding and cutting automata for horn assembly, comprising:

A rack 11; and an enclosure 12 disposed on the rack 11; and an air intake controller 17 and exhaust module 16 arranged on the rack 11; and a man-machine interface module 13 and a dual-control emergency stop button 14 provided on the enclosure 12; and a three-color warning light 15 set on the enclosure 12;

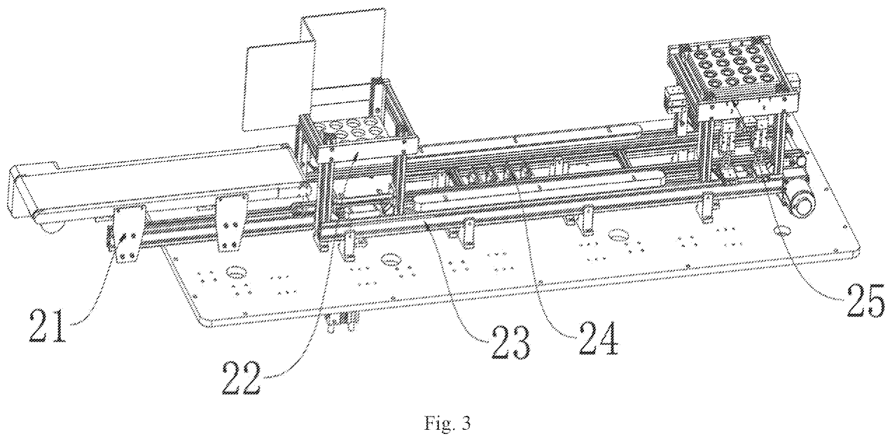

With reference to FIG. 3, the present invention relates to a spot gluing, feeding and cutting automata for horn assembly, further including an automatic feeding and cutting module for horns 20; a feeding and cutting module for horn hoods 30; a grabbing module 40; a gluing module 50; an unloading module 60; and a carrier module 70.

When placing plastic trays with horn products in No. 1 tray carrying module 25 of the automatic feeding and cutting module for horns 20, 20 layers may be stacked at a time. When placing plastic trays with horn hood product in the No. 2 tray carrying module 35 of the automatic feeding and cutting module for horn hoods 30, 20 layers may be stacked at a time. After placement, the sensor 259 for plastic trays loaded with horns and the sensor 359 for plastic trays loaded with horn hoods sense an object, and press the start button in the dual-control emergency stop button 14 for startup.

At this time, No. 3 cylinder 252, No. 4 cylinder 253, No. 5 cylinder 254, No. 6 cylinder 255, No. 7 cylinder 256, No. 8 cylinder 257, and No. 9 cylinder 258 in the No. 1 tray carrying module 25 of the automatic feeding and cutting module for horns 20, as well as No. 9 cylinder 258, No. 10 cylinder 259, No. 11 cylinder 2511, No. 12 cylinder 2512, No. 13 cylinder 2513, No. 14 cylinder 2514, and No. 15 cylinder 2515, which run in the same manner on the opposite side, work together. A plastic tray loaded with horns is automatically placed on the belt module 23 in the automatic feeding and cutting module for horns 20, and the No. 1 motor 236 in the belt module 23 starts to move. When the plastic tray encounters the No. 1 block 244 in No. 1 block module 24, it stops moving and waits for horns to be grabbed.

At the same time, cylinder 351, cylinder 352, cylinder 354, cylinder 355, cylinder 356, cylinder 357, and cylinder 358 of the No. 2 tray carrying module 35 in the automatic feeding and cutting module for horn hoods 30 work together with the cylinders running in the same manner on the opposite side. Place a plastic tray loaded with horn hoods on the belt module 34 in the automatic feeding and cutting module for horns 30, and the No. 3 motor 344 in the belt module 34 starts to move. When the plastic tray encounters the No. 1 block 334 in the No. 3 block module 33, it stops moving and waits for horns to be grabbed.

At this time, No. 6 motor 78 for the screw of the carrier module 70 starts to move, sending No. 2 bearing platform 75 to the assembly position of horns and horn hoods.

The grabbing module 40 starts to work, and the servo motor 412 and the servo motor 49 closely cooperate to move to the position of horn hoods. The stepper motor 47 and the suction cup 43 act to grab horn hoods from the plastic tray for horn hoods to the No. 2 bearing platform 75 back and forth four times.

After the horn hoods are grabbed, the pressing cylinder 76 impacts the products, the No. 1 CCD module 45 moves to the horn position, and starts to take photos for comparison.

After the comparison, the suction cup module 43 moves to the horn position, grabs the horns from the plastic trays with horns four times back and forth and fixes them into the horn hoods. The No. 1 CCD module 45 is required to take photos for comparison every time the horn is captured. If there is an error in the horn angle, it would be compensated by the rotary motor 42. If there is an error in the front, back, left, and right, the servo motor 412 and the servo motor 49 would compensate for it.

At this time, the No. 6 motor 78 and the No. 5 motor 77 of the carrier module 70 start to move, sending the No. 2 bearing platform 75 to the gluing position, and the No. 1 bearing platform 73 to the assembly position of horns and horn hoods. The grabbing module 40 repeats the above actions to grab and place horn hoods and horns into the No. 1 carrier 73.

The gluing module 50 comes into action. First, the No. 2 CCD module 55 takes pictures and positions, and the motor 52 and the No. 6 motor 78 start to do circular spot gluing, applying glue to horn and horn hoods.

By the set trajectory, the gluing module 50 and the carrier module 70 finish four sets of products, and the grabbing module 40 loads materials into the No. 1 carrier 73 to complete feeding.

At this time, the No. 6 motor 78 and the No. 5 motor 77 for the screw of the carrier module 70 start to move, sending the No. 2 bearing platform 75 to the unloading position and the No. 1 bearing platform 73 to the gluing position.

The gluing module 50 repeats the above gluing process, and the motor 52 and the No. 5 motor 77 do circular spot gluing. When the No. 2 bearing platform 75 moves to the position of the unloading module 60, the motor 62, in conjunction with the cylinder 64 and the suction cup 66, starts to load the empty plastic tray. If there is a defective product, it will be picked out and placed on the delivery belt module for defective products 21 for removal.

After the unloading is completed, the No. 6 motor 78 and the No. 5 motor 77 for the screw of the carrier module 70 start to move, sending the No. 2 bearing platform 75 to the initial loading position and the No. 1 bearing platform 73 to the unloading position. The grabbing module 40 and the unloading module 60 repeat the above process and start to work.

After a single cycle is completed, the gluing module 50 needs to move to the glue wiping position where the glue wiping system 335 wipes out the remaining glue on the gluing needle. If the gluing needle is replaced once, the gluing module 50 needs to move to the needle alignment position where the needle alignment system 245 re-aligns and resets the needle.

The automatic feeding and cutting module for horns 20 works in the following sequence: first, the No. 1 tray carrying module 25 puts a tray of horns on the rail 23, and No. 1 motor 236 starts running The plastic trays start to move from the flange where the cover plate 233 clamps the disc, and the No. 1 block 244 is effective. After the first row of horns in the plastic trays for horns, the No. 1 block 244 is reset and the No. 2 block 243 is effective. The above process repeats, the No. 3 block 242 is effective, and the No. 4 block 241 is effective. All the blocks are reset till materials in the tray are completely grabbed.

The empty plastic tray continues to move forward and runs to the position of the No. 1 horn disk recovery module 22. Once the No. 1 sensor 225 senses the presence of an object, the No. 1 cylinder 223 activates to lift an empty tray. The empty tray is held by the ratchet supporting mechanism 222, and the material is collected repeatedly. By the time the tray recovery module has recovered 20 empty trays, the No. 2 cylinder 224 activates to completely eject the empty trays, and an operator takes away a stack of empty trays.

The automatic feeding and cutting module for horn hoods 30 works in the following sequence: first, the No. 2 tray carrying module 35 puts a tray of horn hoods on the No. 2 rail module 34, and No. 3 motor 344 starts running The plastic trays start to move from the flange where the cover plate 346 clamps the disc, and the No. 12 block 334 is effective. After the first row of horn hoods in the plastic trays for horn hoods, the No. 12 block 334 is reset and the No. 11 block 333 is effective. The above process repeats, the No. 10 block 332 is effective, and the No. 9 block 331 is effective. All the blocks are reset till materials in the tray are completely grabbed.

The empty plastic trays continue to move forward and run to the position of the receiving block 32. The No. 8 block 324 is effective, and the receiving module 60 starts to load the finished products on the No. 2 bearing platform 75 and the No. 1 bearing platform 73 on the carrier module 70 to the first row of the empty trays. The No. 7 block 323 is effective, the No. 8 block 324 is reset, and the previous process is repeated. In turn, the No. 6 block 322 is effective, and the No. 5 block 321 is effective. When four rows are fully filled, all blocks are reset.

The plastic trays carrying finished products continue to move forward and run to the position of the No. 2 horn disk recovery module 31. Once the No. 2 sensor 315 senses the presence of an object, the No. 16 cylinder 223 activates to lift a finished product tray. The finished product tray is held by the ratchet supporting mechanism 312, and the material is collected repeatedly. By the time the tray recovery module has recovered 20 finished product trays, an operator takes away a stack of trays.

Wherein the automatic feeding and cutting module for horns 20 comprises the delivery belt module for defective products 21, No. 1 horn disk recovery module 22, No. 1 rail module 23, No. 1 block module 24, and No. 1 tray carrying module 25.

The delivery belt module for defective products 21 includes No. 1 skeleton 211, fixed vertical plate 212, belt line 213, and No. 1 motor 214;

No. 1 horn disk recovery module 22 comprises No. 1 skeleton 221, No. 1 ratchet rod 222, No. 1 cylinder 223, No. 2 cylinder 224, and No. 1 sensor 225.

No. 1 rail module 23 includes No. 1 be1t231, No. 5 skeleton 232, No. 1 block 233, fixing block for No. 1 skeleton 234, fixing frame for No. 1 belt 235, and No. 1 motor 236.

Wherein the feeding and cutting module for horn hoods 30 comprises No. 2 horn disk recovery module 31, No. 2 block module 32, No. 3 block module 33, No. 2 rail module 34, and No. 2 tray carrying module 35.

No. 2 horn disk recovery module 31 includes No. 3 skeleton 311, No. 2 ratchet rod 312, guard plate 313, No. 16 cylinder 314, and No. 2 sensor 315.

No. 2 rail module 34 comprises No. 2 belt 342, No. 4 skeleton 341, No. 2 block 345, fixing block for No. 1 skeleton 347, and No. 4 motor 343.

Wherein the grabbing module 40 includes No. 1 column 41, a rotary motor 42, a gripping module 43, a light source 44, No. 1 CCD module 45, No. 1 Z-direction screw 46, No. 1 Z-axis motor 47, and a Y-direction screw 48, a Y-axis motor 49, No. 1 X-direction screw 411, No. 1 X-axis motor 412, and fixed code 413.

Wherein the gluing module 50 includes No. 2 column 51, No. 2 X-axis motor 52, a gluing system 53, No. 2 Z-direction screw 54, No. 2 CCD module 55, No. 2 Z-axis motor 56, and No. 2 X-direction screw 57, and fixed code 58.

Wherein the unloading module 60 includes No. 3 column 61, No. 3 X-axis motor 62, No. 3 X-direction screw 63, a Z-direction (1) sliding table 64, a Z-direction (2) sliding table 65, No. 1 suction cup 66, No. 2 suction cup 67, and fixed code 68.

Wherein the carrier module 70 includes No. 1 screw 71, No. 2 screw 72, No. 1 bearing platform 73, No. 2 bearing platform 75, No. 1 pressure cylinder 74, No. 2 pressure cylinder 76, No. 5 motor 77, and No. 6 motor 78.

Repeated continuous operation thus starts such that products are transported and delivered through an automatic feeding and cutting module for horns and horn hoods; horns and horn hoods are grabbed onto a bearing platform module by a grabbing module; circular spot gluing is done by a gluing module and a carrier module; and finally horn disks are automatically assembled by an unloading module with defective products removed. Different workstations perform their duties and work closely together, so as to realize the automatic delivery of products, automatic assembly of horns into horn hoods, automatic gluing, and automatic assembly and recovery of horn disks. The automata features high efficiency, stable quality, high degree of automation, good effect, low production cost, and convenient, simple and fast use.

Finally, it shall be noted that the above descriptions are only preferred embodiments of the present invention, and are not intended to limit the present invention. Although the present invention has been described in detail with reference to the foregoing embodiments, those skilled in the art may still modify the technical solutions described in the foregoing embodiments, or equivalently replace some of the technical features. Any modification, equivalent replacement, improvement, etc., made within the spirit and principle of the present invention shall be included in the protection scope of the present invention.

What is claimed is:

1. A spot gluing, feeding and cutting automata for horn assembly, wherein it consists of:
a rack (11), and
an enclosure (12) disposed on the rack (11); and
an automatic feeding and cutting module for horns (20) arranged on the rack (11), which automatically feeds horns and automatically recovers plastic trays with horns; and
a feeding and cutting module for horn hoods (30) arranged on the rack (11), which realizes automatic feeding of horn hoods and automatic recovery of plastic trays with horn hoods; and
a grabbing module (40) arranged on the rack (11), which is assisted by CCD to realize grabbing of horn hoods and the horns; and
a gluing module (50) arranged on the rack (11), which, with the assistance of CCD, does gluing for solidification after horns are fixed into horn hoods; and
an unloading module (60) arranged on the rack (11), which is used for automatic loading of finished products, and selection and removal of defective products; and
a carrier module (70) provided on the rack (11), which is used as a bearing platform; and
an exhaust module (16) provided at the bottom of the rack (11), which is used to cool the control system in the cabinet; and
a three-color warning light (15) set on the enclosure (12), which is used to indicate different operating states of the machine; and
a man-machine interface module (13) arranged on the enclosure (12).

2. A spot gluing, feeding and cutting automata for horn assembly according to claim 1, wherein it further comprises:
a double-control emergency stop button (14) arranged on the front of the upper panel to the enclosure (12).

3. A spot gluing, feeding and cutting automata for horn assembly according to claim 1, wherein the automatic feeding and cutting module for horns (20) comprises:
a delivery belt module for defective products (21);
No. 1 horn disk recovery module (22), one end of which is connected to the delivery belt module for defective products (21);
No. 1 rail module (23), one end of which is connected to the other end of the No. 1 horn disk recovery module (22);
No. 1 block module (24), which is disposed above the No. 1 rail module (23);
No. 1 tray carrying module (25), one end of which is connected to one end of the block module (24).

4. A spot gluing, feeding and cutting automata for horn assembly according to claim 3, wherein the delivery belt module for defective products (21) comprises:
No. 1 skeleton (211);
a fixed vertical plate (212), which is connected to both sides of the No. 1 skeleton (211);
a belt line (213), which is provided above the No. 1 skeleton (211);
No. 1 motor (214), which is provided at one end of the belt line (213);
The No. 1 horn disk recovery module (22) includes:
No. 1 skeleton (221);
No. 1 ratchet rod (222), which is arranged below the No. 1 skeleton (221);
No. 1 cylinder (223), which is provided below the No. 1 ratchet rod (222);
No. 2 cylinder (224), which is provided below the No. 1 cylinder (223);
No. 1 sensor (225), which is arranged on one side of the No. 1 ratchet rod (222).
The No. 1 rail module (23) includes:
No. 1 belt (231);
No. 5 skeleton (232), which is provided below the No. 1 belt (231);
No. 1 block (233), which is provided on one side of the No. 1 belt (231);
a fixing block (234) for No. 1 skeleton, which is provided at the bottom of the No. 5 skeleton (232);
a fixing frame for No. 1 belt (235), which is provided on one side of the fixing block for No. 1 skeleton (234);
No. 1 motor (236), which is provided at one end of the No. 1 belt (231).

5. A spot gluing, feeding and cutting automata for horn assembly according to claim 1, wherein the feeding and cutting module for horn hoods (30) comprises:
No. 2 horn disk recovery module (31);
No. 2 block module (32), which is provided on one side of the No. 2 horn disk recovery module (31);
No. 3 block module (33), which is provided on one side of the No. 2 block module (32);
No. 2 rail module (34), which is provided on one side of the No. 3 block module (33);
No. 2 tray carrying module (35), which is arranged on one side of the No. 2 rail module (34).

6. A spot gluing, feeding and cutting automata for horn assembly according to claim 1, wherein the No. 2 horn disk recovery module (31) includes:
No. 3 skeleton (311), No. 2 ratchet rod (312), a guard plate (313), No. 16 cylinder (314), No. 2 sensor (315);
No. 2 rail module (34) includes No. 2 belt (342), No. 4 skeleton (341), No. 2 block (345), a fixing block for No. 1 skeleton (347), No. 4 motor (343), and No. 3 motor (344).
